(19) United States
(12) Patent Application Publication
(10) Pub. No.: US 2024/0047111 A1
(43) Pub. Date: Feb. 8, 2024

(54) Functional Gradients To Tailor Magnetic Fields

(71) Applicant: Board of Regents, The University of Texas System, Austin, TX (US)

(72) Inventor: Joshua Green, El Paso, TX (US)

(21) Appl. No.: 18/360,016

(22) Filed: Jul. 27, 2023

Related U.S. Application Data
(60) Provisional application No. 63/370,463, filed on Aug. 4, 2022.

(51) Int. Cl. H01F 7/02; H01F 7/06; H01F 41/02

(52) U.S. Cl. CPC H01F 7/0205; H01F 7/06; H01F 41/02

(57) ABSTRACT

An apparatus includes a number of magnetic materials distributed in the apparatus. Magnetic property profiles for the number of magnetic materials are facilitated by functionally grading the volume fractions and local magnetic properties that are associated with a force profile that includes a number of forces acting on the apparatus. The magnetic materials can include at least one of paramagnetic material, diamagnetic material, and ferromagnetic material. In addition, the apparatus can also include a number of supporting devices that apply forces on the apparatus. The number of supporting devices includes at least one of permanent magnets, electromagnets, springs, and bearings.

### CROSS-REFERENCE TO RELATED APPLICATION

This application claims the benefit of U.S. Provisional Patent Application Ser. No. 63/370,463, filed Aug. 4, 2022, and entitled “Functional Gradients in Additive Manufacturing to Tailor Magnetism or Magnetic Fields,” which is incorporated herein by reference in its entirety.

### BACKGROUND

### 1. Field

The disclosure relates generally to magnetic material and more specifically to magnetic material for electromechanical systems for developing magnetism in a desired profile.

### 2. Description of the Related Art

A magnet is an object or material that produces a magnetic field that exerts attractive forces on opposite poles and repulsive forces on same poles. Magnets can be used in a wide variety of devices that utilize magnetic forces mediated by magnetic fields that result in attractive and repulsive forces between entities.

Magnetic materials are materials that exhibit magnetic properties and can generate and respond to magnetic fields. For example, ferromagnetic material is a type of magnetic material that exhibits strong magnetic properties. Ferromagnetic materials can have spontaneous magnetization so that they can become permanently magnetized in the absence of an external magnetic field.

The atoms in ferromagnetic materials align in a specific pattern to create magnetic domains. Ferromagnetic materials become magnetized and exhibit strong magnetic properties when the magnetic domains created by atoms in ferromagnetic materials are aligned. In this case, ferromagnetic materials can retain magnetization for extended periods, making the ferromagnetic materials useful for several applications such as magnets, transformers, motors, drivers, and sensors.

Intensive properties for magnetic material are the material properties which do not change with the amount of material, and extensive properties for magnetic material are the material properties which change with the amount of material. The behavior of ferromagnetic material can be influenced by environmental factors like temperature, external magnetic fields, and presence of magnetic materials in a close range.

### SUMMARY

An illustrative embodiment of the present disclosure provides an apparatus comprising: a number of magnetic materials distributed in the apparatus according to a magnetic property profile and a force profile comprising a number of forces acting on the apparatus, wherein the magnetic property profile comprises magnetic properties that are associated with forces in the force profile for the number of magnetic materials.

Another illustrative embodiment of the present disclosure provides a method for manufacturing a number of magnetic materials, comprising: determining a force profile for the number of magnetic materials, wherein the force profile for the number of magnetic materials is determined for altering the magnetic field of an electromechanical system; determining a distribution for the number of magnetic materials based on volume fractions for the number of magnetic materials using the force profile; and producing the number of magnetic materials using the distribution and the volume fractions for the number of magnetic materials.

Another illustrative embodiment of the present disclosure is a method for manufacturing a number of magnetic materials, comprising: determining a force profile for the number of magnetic materials, wherein the force profile for the number of magnetic materials is determined for altering the magnetic field of an electromechanical system; determining a magnetic force profile for the number of magnetic materials using the force profile; determining a magnetic property profile and volume fractions for the number of magnetic materials using the magnetic force profile, wherein the volume fractions for the number of magnetic materials comprises concentration of magnetic particles and voids in a material structure for the number of magnetic materials; determining a distribution for the number of magnetic materials based on the magnetic property profile and volume fractions for the number of magnetic materials; generating a manufacturing plan for the number of magnetic materials; additively manufacturing the number of magnetic materials using the distribution for the number of magnetic materials and the manufacturing plan; generating a magnetic structure for an electromagnetic system using the number of magnetic materials; and configuring a number of supporting devices for the number of magnetic materials, wherein the number of supporting devices applies forces to the number of magnet materials.

Other objects, features and advantages of the present disclosure will become apparent from the following detailed description. It should be understood, however, that the detailed description and the specific examples, while indicating preferred embodiments of the present disclosure, are given by way of illustration only, since various changes and modifications within the spirit and scope of the present disclosure will become apparent to those skilled in the art from this detailed description.

### BRIEF DESCRIPTION OF THE DRAWINGS

FIG. 1 illustrates resultant magnetic force from a number of forces between the functionally graded distribution of magnetic particles paired with a permanent magnet in accordance with an illustrative embodiment;

FIG. 2 illustrates an exemplary single sawtooth distribution of magnetic particles in accordance with an illustrative embodiment;

FIG. 3A illustrates an exemplary double sawtooth distribution of magnetic particles in accordance with an illustrative embodiment;

FIG. 3B illustrates a three dimensional diagram for magnetic material in cylinder shape with desired distribution along a vertical axis in accordance with an illustrative embodiment.

FIG. 4 illustrates an exemplary multistep distribution of magnetic particles in accordance with an illustrative embodiment;

FIG. 5A illustrates an exemplary quadratic distribution of magnetic particles in accordance with an illustrative embodiment.

FIG. 5B illustrates a three dimensional diagram for magnetic material in cylinder shape with desired distribution along a vertical axis in accordance with an illustrative embodiment.

FIG. 6 illustrates an exemplary single-ramp distribution of magnetic materials facilitated by porosity in accordance with an illustrative embodiment.

FIG. 7 illustrates exemplary multidimensional distributions of magnetic particles in accordance with an illustrative embodiment.

FIG. 8 illustrates a flowchart of a process for producing magnetic materials for an electromechanical system in accordance with an illustrative embodiment.

FIG. 9 illustrates a flowchart of a process for manufacturing magnetic materials in accordance with an illustrative embodiment.

### DETAILED DESCRIPTION

The illustrative embodiments recognize and take into account a number of different considerations as described herein. For example, the illustrative embodiments recognize and take into account that functional gradients have been observed to improve material properties across design motifs. These design motifs provide improved material strength and toughness, which are often compromised through other techniques.

The illustrative embodiments also recognize and take into account that functional gradients of ferromagnetic particles can be used to create distributions that result in customized magnetic fields and magnetic characteristics that generate forces between entities.

The illustrative embodiments also recognize and take into account that additive manufacturing has expanded development of functionally graded structures that can be used for many applications. For example, the additively manufactured structure with functional gradients can be used for motors, magnetic resonance imaging scanners, sensors, solenoids, transformers, inductive heaters, and valves.

As used herein, when used with reference to items, “a number of” means one or more of the items. For example, “a number of different types of communication networks” is one or more different types of communication networks. Similarly, “a set of,” when used with reference to items, means one or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combination of these items may be present. In some illustrative examples, “at least one of” may be, for example, without limitation, two of item A; one of item B; and ten of item C; four of item B and seven of item C; or other suitable combinations.

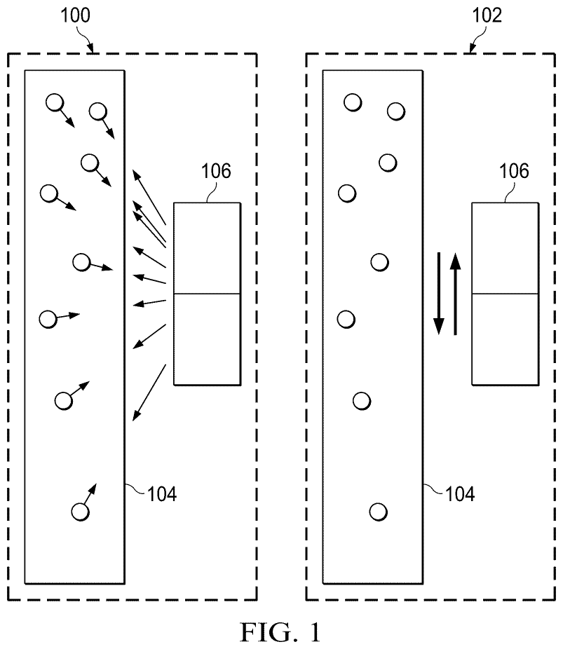

With reference now to the figures, and in particular, with reference to FIG. 1, an illustration of resultant magnetic force from a number of forces between the functionally graded distribution of magnetic particles paired with permanent magnet is depicted in accordance with an embodiment of this disclosure. In this illustrative example, the functional graded distribution shows a material or structure that exhibits a gradual and controlled variation in its composition. The functional graded distribution shows magnetic properties for magnetic particles paired with permanent magnets through varying volume fraction of magnetic materials.

Volume fraction is the volume of a material feature or constituent in a region relative to the total volume of that region. Volume fraction is unitless and is often reported as a percentage. Volume fraction may indicate proportions of any material feature including but not limited to composition, constituents, arrangements, distribution, grain size, dimensions, orientations, porosity, pore size, phases, crystallinity, and properties. The volume fraction may correspond to a region of any scale such as macroscale, mesoscale, microscale, and nanoscale and is not necessarily indicative of the whole material as the material may be comprised of regions with different volume fractions.

Local magnetic properties are the effective intrinsic and extrinsic magnetic properties of a local region of a material. The local magnetic properties can be influenced by the corresponding mass fraction and volume fraction of the material feature in that region.

In FIG. 1, magnetic property is facilitated by varying magnetic material volume fractions via particle distribution. Particle distributions are paired with permanent magnets such that forces are created from the interaction between magnetic particles and permanent magnets. For example, pairing 100 includes distribution of magnetic particles 104 and permanent magnets 106. In this illustrative example, distribution of magnetic particles 104 includes magnetic particles with a force acting on each particle and the corresponding opposite force acting on the permanent magnets 106. Pairing 102 shows a sum of the vertical components of forces acting on the distribution of magnetic particles 104 and permanent magnets 106. The forces shown in pairing 100 illustrate the effect of particle distribution which results in a net effect shown in pairing 102. In this illustrative example, pairing 100 and pairing 102 can be examples of electromechanical systems or portions of electromechanical systems, and such distributions can be adjusted to facilitate a force profile which changes with position. In other words, distribution of magnetic particles can be adjusted such that electromechanical systems will operate according to the force profile.

In this example, magnetic particles for distribution of magnetic particles 104 can be selected from a number of magnetic materials such as paramagnetic materials, diamagnetic materials, ferromagnetic materials, or particles for any suitable magnetic materials.

In this illustrative example, distribution of magnetic particles 104 can be determined using force profiles for pairing 100 and pairing 102. For example, a force profile that includes information associated with desired forces that are acting on magnetic particles and permanent magnets 106 in pairing 100 can be used to determine distribution of magnetic particles 104. In other words, distribution of magnetic particles 104 can be tailored based on desired forces acting on magnetic particles and permanent magnets.

In this illustrative example, the force profiles for distribution of magnetic particles 104 can include locations of equilibrium, force direction, force magnitude, and any suitable information related to desired forces acting on particles for distribution of magnetic particles 104.

In this example, the distribution of magnetic particles 104 alters the local magnetic properties which affect magnetic force. In this illustrative example, local magnetic properties such as desired physical characteristics and chemical characteristics contribute to performance of magnetic materials used in pairing 100 and pairing 102. Magnetic force can be tailored by customizing the volume fractions for magnetic materials used in pairing 100 and pairing 102. In this example, the volume fractions include concentrations and size of magnetic particles for magnetic materials used in pairing 100 and pairing 102. In this illustrative example, multiple magnetic materials can be used as magnetic materials in pairing 100 and pairing 102. In this illustrative example, electromagnets and multiple permanent magnets having a variety of shapes, sizes, orientations, compositions, and grades can be used for permanent magnets 106. Local magnetic properties associated with magnetic forces as illustrated in pairing 100 and pairing 102 can be customized spatially to form a magnetic property profile associated with a magnetic force profile. Distribution of volume fractions for magnetic particles can be adjusted such that electromechanical systems will operate according to magnetic forces in a force profile.

Further, the magnetic properties of magnetic materials used in pairing 100 and pairing 102 can also be tailored to form a magnetic property profile. In this illustrative example, a magnetic property profile includes local magnetic properties such as desired physical characteristics and chemical characteristics that contribute to performance of magnetic materials used in pairing 100 and pairing 102. For example, the magnetic property profile can include microstructure, dimension, arrangement, orientation, or any suitable physical and structural characteristics for magnetic materials used in pairing 100 and pairing 102. As depicted, local magnetic properties associated with magnetic forces as illustrated in pairing 100 and pairing 102 can be customized spatially to form a magnetic property profile associated with a magnetic force profile.

As a result, distribution of magnetic particles 104 can be determined using the magnetic force profile and the magnetic property profile as depicted above.

In this illustrative example, distribution of magnetic particles 104 can be used to manufacture magnetic materials using manufacturing techniques such as additive manufacturing. In this illustrative example, a manufacturing process plan can be created for manufacturing magnetic materials using distribution of magnetic particles 104. For example, the manufacturing process plan can include configuration of thermodynamic processes, distribution of binders, curing times, path planning, raster planning, or any suitable configuration associated with manufacturing process for magnetic materials.

It should be understood that the illustrated diagram is only one embodiment of the present disclosure. For example, permanent magnets 106 can be replaced by other supporting devices such as electromagnets, springs, bearings, and any suitable mechanisms. In addition, the illustration of pairing 100 and pairing 102 in FIG. 1 is provided as a simplified view for purposes of explaining features in the different illustrative examples. As depicted, pairing 100 and pairing 102 are shown in two dimensions when in actuality, embodiment in one dimension and three dimensions can also be present for distribution of magnetic particles and supporting devices as depicted above. For example, pairing 100 and pairing 102 can include planar distribution and non-planar distribution for magnetic materials.

Magnets are used in a wide variety of electromechanical devices such as motors, magnetic resonance imaging scanners, sensors, solenoids, transformers, inductive heaters, and valves. Some of these devices utilize force developed by magnets which is known as magnetism mediated by magnetic fields resulting in attractive and repulsive forces between entities.

Electromechanical systems with control elements are commonly used to tailor loads and often need components like motors, power sources, drivers, and sensors to complete works. The method illustrated in FIG. 1 provides an opportunity to improve electromechanical systems by using force profiles and magnetic properties that vary spatially. For example, the method illustrated in FIG. 1 can be applied to a motor to alter the magnetic field for purposes of reducing torque ripple. In this example, torque ripple is a phenomenon where torque produced by a motor is not constant throughout its range of motion. In another example, the products created through the method illustrated in FIG. 1 can be used instead of an electromechanical system. In this case, the products can achieve comparable outcomes by using a functionally graded magnetic structure paired with a permanent magnet to develop magnetism in a desired profile without need of a power supply, controller, or sensors.

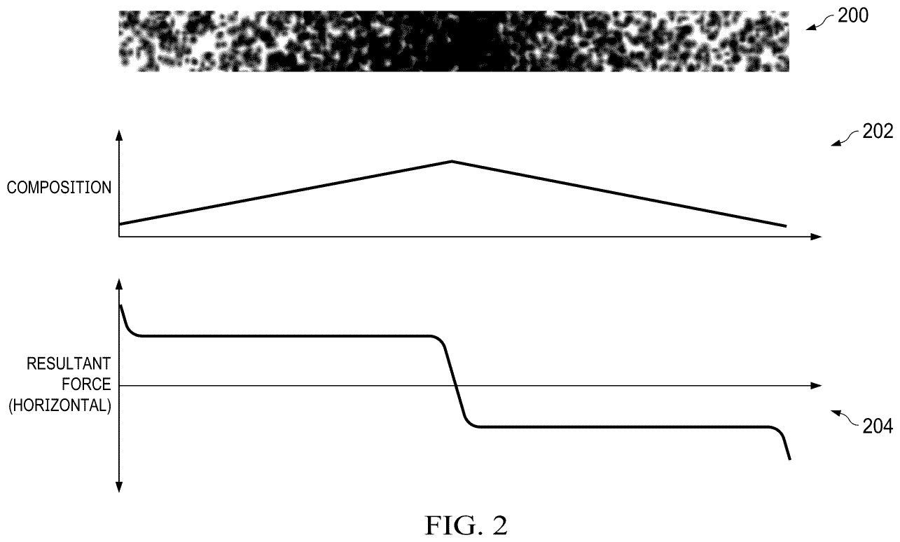

With reference now to FIG. 2, an illustration of an exemplary single sawtooth distribution of magnetic particles is depicted in accordance with an illustrative embodiment. Distribution 200 is an example of distribution for magnetic particles 104 in FIG. 1.

In FIG. 2, distribution 200 shows magnetic particles that have a composition following a single sawtooth function along a horizontal axis, as illustrated in plot 202. In this illustrative example, distribution 200 includes magnetic particles that exhibit a pattern that starts at a first concentration and gradually increases the concentration in a linear fashion until it reaches a peak and then drops back to the starting concentration.

Magnetic particles for distribution 200 can result in a net horizontal force acting on a permanent magnet along the corresponding path, as illustrated by plot 204. In other words, the magnetic material generated using distribution 200 can result in magnetic forces along the magnetic material that gradually increase in a linear fashion until reaching a peak and then decrease to the starting level in a linear fashion.

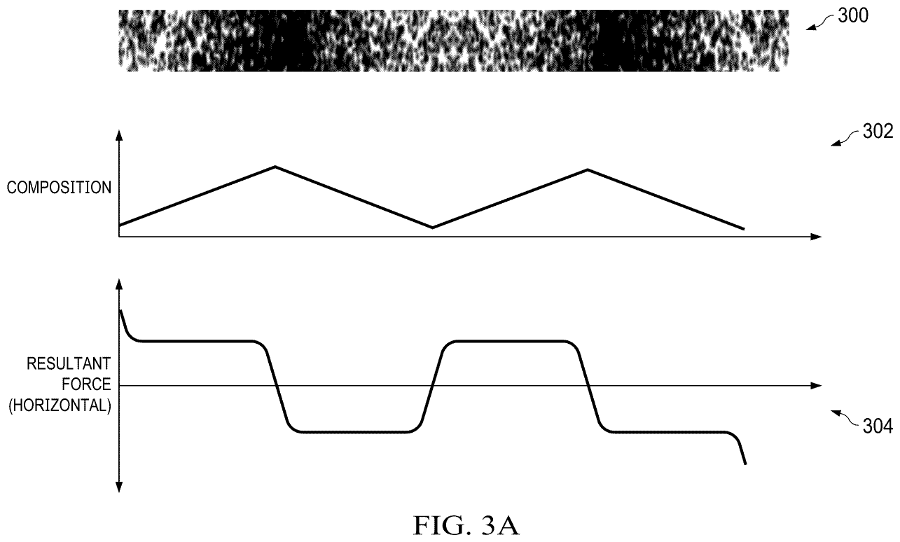

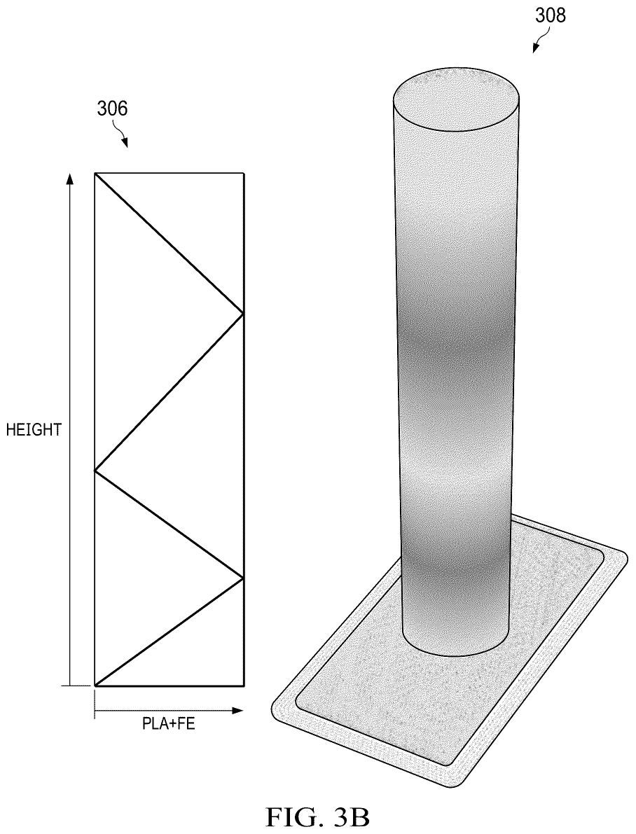

With reference now to FIG. 3A, an illustration of an exemplary double sawtooth distribution of magnetic particles is depicted in accordance with an illustrative embodiment. Distribution 300 is an example of distribution for magnetic particles 104 in FIG. 1.

Distribution 300 shows magnetic particles that have a composition following a double sawtooth function along a horizontal axis, as illustrated in plot 302. In this illustrative example, distribution 300 includes magnetic particles that exhibit a pattern that starts at a first concentration and gradually increases the concentration in a linear fashion until it reaches a peak and then drops back to the starting concentration. The concentration of magnetic particles repeats the pattern described above before resetting to the starting concentration.

Magnetic particles for distribution 300 can result in a net horizontal force acting on a permanent magnet along the corresponding path, as illustrated by plot 304. In other words, the magnetic material generated using distribution 300 can result in magnetic forces along the magnetic material that gradually increase in a linear fashion until reaching a peak and decrease to the starting level in a linear fashion, and repeats the pattern for a second time before resetting to the starting level.

FIG. 3B shows a three-dimensional illustration of magnetic material in cylinder shape with desired distribution along a vertical axis in accordance with an illustrative embodiment. In this illustrative example, the desired distribution can be distribution 300. As depicted, magnetic material 308 can be manufactured with distribution 300 determined using methods illustrated in FIG. 1. Plot 306 shows a composition for magnetic material 308 along the height of magnetic material 308. In this example, magnetic material 308 is created using a ferromagnetic composite formed using iron particles suspended in polylactic acid matrix. In plot 306, the concentration of ferromagnetic composite follows double sawtooth function as shown in distribution 300.

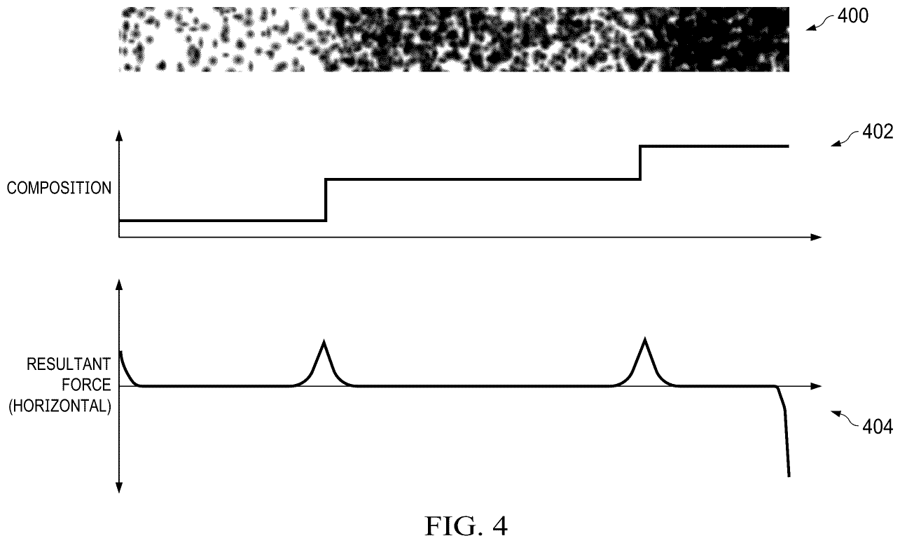

With reference now to FIG. 4, an illustration of an exemplary multistep distribution of magnetic particles is depicted in accordance with an illustrative embodiment. Distribution 400 is an example of distribution for magnetic particles 104 in FIG. 1.

In FIG. 4, distribution 400 shows magnetic particles that have a composition following a double steps function along a horizontal axis, as illustrated in plot 402. In this illustrative example, distribution 400 includes magnetic particles that exhibit a stepwise pattern that starts at a first concentration and remains constant at the starting concentration before transitioning to a higher second concentration and remains constant at the higher concentration. The pattern then transitions to a third, highest concentration and remains constant at that level.

Magnetic particles for distribution 400 can result in a net horizontal force acting on a permanent magnet along the corresponding path, as illustrated by plot 404. In other words, the magnetic material generated using distribution 400 can result in magnetic forces along the magnetic material that remain constant at two levels and abruptly transition between these two levels.

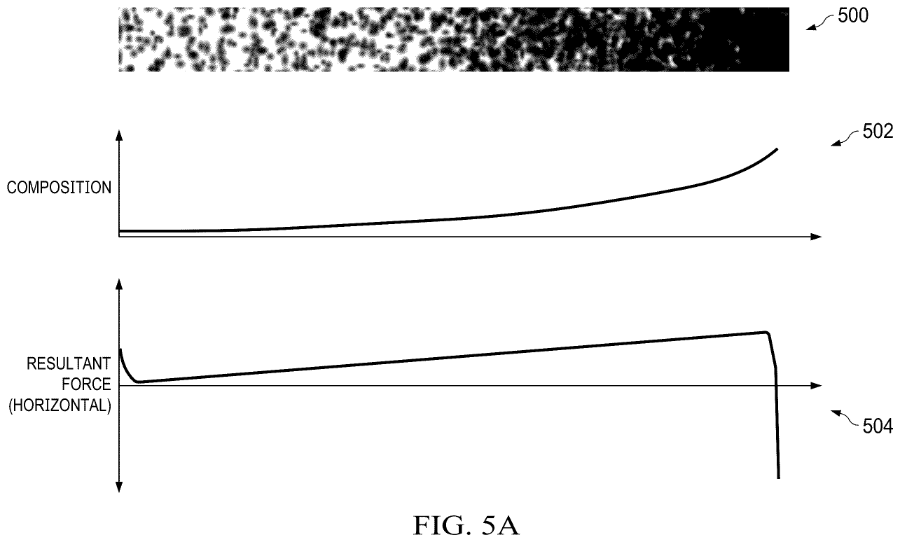

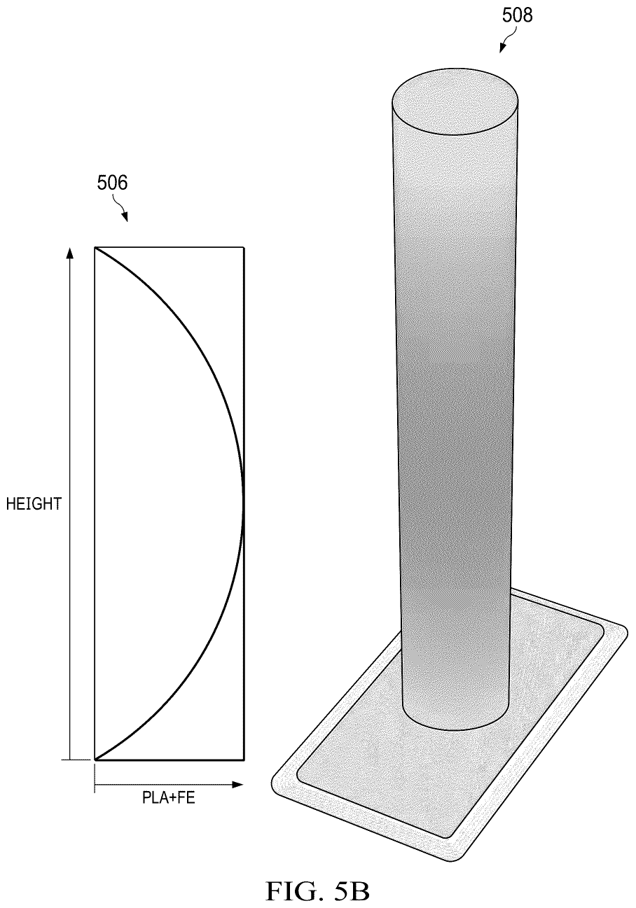

With reference now to FIG. 5A, an illustration of an exemplary quadratic distribution of magnetic particles is depicted in accordance with an illustrative embodiment. Distribution 500 is an example of distribution for magnetic particles 104 in FIG. 1.

Distribution 500 shows magnetic particles that have a composition following a quadratic function along a horizontal axis, as illustrated in plot 502. In this illustrative example, distribution 500 includes magnetic particles that exhibit a pattern that starts at first concentration and increases the concentration at an accelerated rate. In other words, distribution 500 includes the lowest concentration of magnetic particles at one end and the highest concentration of magnetic particles at the other end.

In this example, magnetic particles for distribution 500 can result in a net horizontal force acting on a permanent magnet along the corresponding path, as illustrated by plot 504. In other words, the magnetic material generated using distribution 500 can result in magnetic forces such that the magnetic forces change at an accelerating or decelerating rate along the magnetic material.

FIG. 5B shows a three-dimensional illustration of magnetic material in cylinder shape with desired distribution along a vertical axis in accordance with an illustrative embodiment. In this illustrative example, the desired distribution can be the distribution shown in plot 506. As depicted, magnetic material 508 can be manufactured with distribution shown in plot 506. In this illustrative example, distribution shown in plot 506 can be determined using methods described in FIG. 1. Plot 506 shows a composition for magnetic material 508 as the height of magnetic material 508 increases. In this example, magnetic material 508 is created using a ferromagnetic composite formed using iron particles suspended in polylactic acid matrix. In plot 506, the concentration of ferromagnetic composite follows a quadratic function in shape of parabola as shown in distribution 500. In this illustrative example, the magnetic forces created by magnetic material 508 are the weakest in the middle of magnetic material 508 and are the strongest at the two ends of magnetic material 508. As depicted, the magnetic forces created by magnetic material 508 cross zero net force at the center and have lower slopes in composition change near the center.

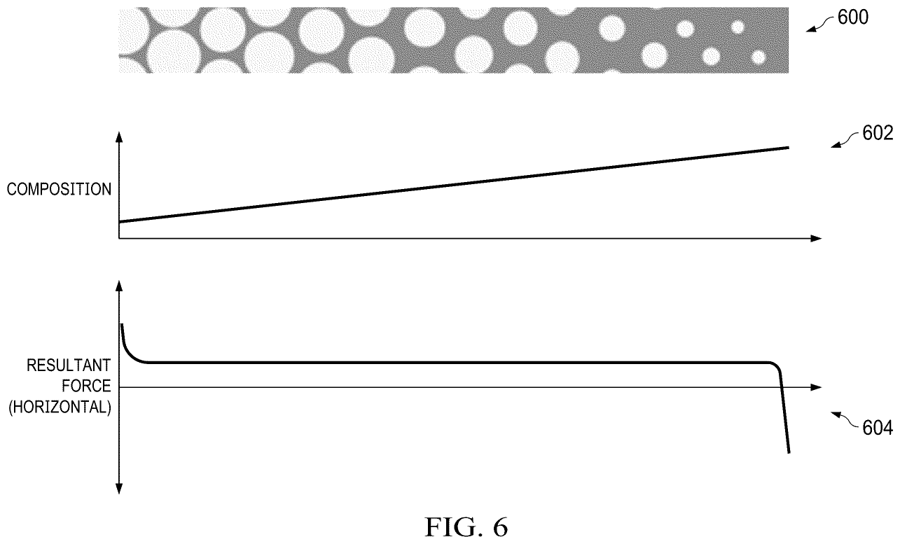

With reference now to FIG. 6, an illustration of an exemplary single-ramp distribution of magnetic material facilitated by porosity is depicted in accordance with an illustrative embodiment. Distribution 600 is an example of distribution for magnetic particles 104 in FIG. 1.

In FIG. 6, distribution 600 shows magnetic particles that have a composition following a linear function along a horizontal axis, as illustrated in plot 602. In this illustrative example, distribution 600 includes volume fractions for magnetic material that exhibit a pattern that starts at a first concentration and gradually increases the concentration at a constant rate.

In this example, volume fractions for magnetic materials for distribution 600 can result in a net horizontal force acting on a permanent magnet along the corresponding path, as illustrated by plot 604. In other words, the magnetic material generated using distribution 600 can result in magnetic forces that increase and decrease in a uniform manner along the magnetic material.

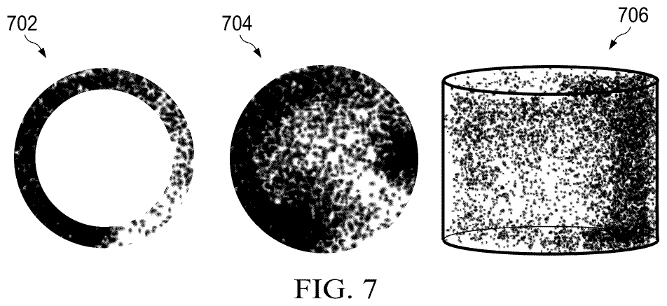

With reference now to FIG. 7, an illustration of exemplary non-planar distributions of magnetic particles is depicted in accordance with an illustrative embodiment. Distribution 702, distribution 704, and distribution 706 are examples of distribution for magnetic particles 104 in FIG. 1.

As depicted, functional gradients from distribution of magnetic particles can be formed along multiple dimensions. In this example, distribution 702 illustrates a functional gradient from distribution of magnetic particles that follows a non-linear path. Distribution 704 illustrates a functional gradient from distribution of magnetic particles that follows a planar distribution in the shape of a circle. Distribution 706 illustrates a three-dimensional volumetric distribution in the shape of a cylinder.

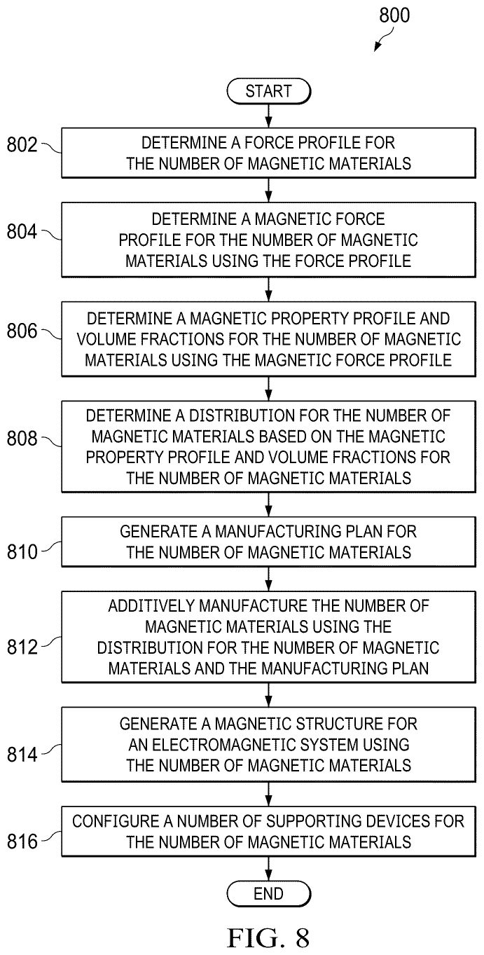

Turning next to FIG. 8, a flowchart of a process for producing magnetic materials for an electromechanical system is depicted in accordance with an illustrative embodiment. The process in FIG. 8 can be implemented to produce magnetic materials using distribution of magnetic particles 104 in FIG. 1.

Process 800 begins by determining a force profile for a number of magnetic materials (step 802). In step 802, the force profile is a representation that describes how forces change with respect to parameters or conditions for the number of magnetic materials. In this example, the force profile correlates to the magnetism response field of an electromechanical system.

Process 800 determines a magnetic force profile for the number of magnetic materials using the force profile (step 804). Process 800 determines a magnetic property profile and volume fractions for the number of magnetic materials using the magnetic force profile (step 806). In step 806, the volume fractions for the number of magnetic materials include concentration of magnetic particles and voids in a material structure for the number of magnetic materials.

Process 800 determines a distribution for the number of magnetic materials based on the magnetic property profile and volume fractions for the number of magnetic materials (step 808). Process 800 generates a manufacturing plan for the number of magnetic materials (step 810). Process 800 additively manufactures the number of magnetic materials using the distribution for the number of magnetic materials and the manufacturing plan (step 812).

Process 800 generates a magnetic structure for an electromagnetic system using the number of magnetic materials (step 814). Process 800 configures a number of supporting devices for the number of magnetic materials (step 816). In step 816, the number of supporting devices can apply forces to the number of magnetic materials. The process terminates thereafter.

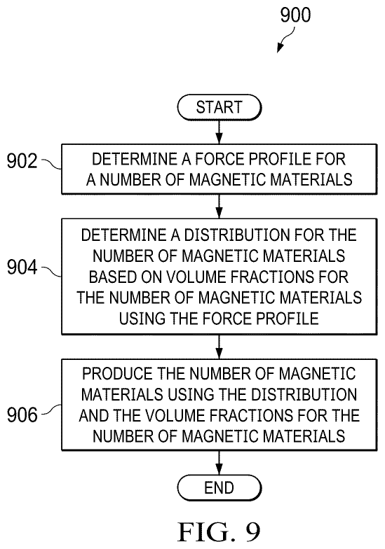

Turning next to FIG. 9, a flowchart of a process for manufacturing magnetic materials is depicted in accordance with an illustrative embodiment. The process in FIG. 9 can be implemented to produce magnetic materials using distribution of magnetic particles 104 in FIG. 1.

The process begins by determining a force profile for a number of magnetic materials (step 902). In step 902, the force profile correlates to varying magnetic properties in an electromechanical system. The process determines a distribution for the number of magnetic materials based on volume fractions for the number of magnetic materials using the force profile (step 904). The process produces the number of magnetic materials using the distribution and the volume fractions for the number of magnetic materials (step 906). The process terminates thereafter.

All of the methods disclosed and claimed herein can be made and executed without undue experimentation in light of the present disclosure. While the compositions and methods of the present disclosure have been described in terms of preferred embodiments, it will be apparent to those of skill in the art that variations may be applied to the methods and in the steps or in the sequence of steps of the method described herein without departing from the concept, spirit, and scope of the present disclosure. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the present disclosure as defined by the appended claims.

What is claimed is:

1. An apparatus, comprising:
a number of magnetic materials distributed in the apparatus according to a magnetic property profile and a force profile comprising a number of forces acting on the apparatus, wherein the magnetic property profile comprises magnetic properties that are associated with forces in the force profile for the number of magnetic materials.

2. The apparatus of claim 1, further comprising:
a number of supporting devices, wherein the number of supporting devices applies forces on the apparatus.

3. The apparatus of claim 2, wherein the number of supporting devices comprise at least one of permanent magnets, electromagnets, springs, and bearings.

4. The apparatus of claim 1, wherein the number of magnetic materials comprise at least one of paramagnetic material, diamagnetic material, and ferromagnetic material.

5. The apparatus of claim 1, wherein the number of magnetic materials comprise ferromagnetic particles suspended in a polymer matrix to form a ferromagnetic composite for the apparatus.

6. The apparatus of claim 1, wherein the distribution of magnetic materials is configured to form gradients in one dimension, two dimensions, or three dimensions, and wherein the distribution of magnetic materials create force profiles in one dimension, two dimensions, or three dimensions.

7. The apparatus of claim 1, wherein volume fraction distribution of magnetic materials is configured to facilitate the magnetic property profile.

8. The apparatus of claim 7, wherein the number of magnetic materials have a geometry that varies in topology or porosity.

9. The apparatus of claim 7, wherein the number of magnetic materials have a truss-lattice geometry that varies in density.

10. The apparatus of claim 1, wherein distribution of magnetic material is configured to follow a single sawtooth, a double sawtooth, a multistep function, quadratic function, or a linear function along a path.

11. A method for manufacturing a number of magnetic materials, the method comprising:
determining a force profile for the number of magnetic materials, wherein the force profile correlates to varying magnetic properties in an electromechanical system;
determining a distribution for the number of magnetic materials based on volume fractions for the number of magnetic materials using the force profile; and
producing the number of magnetic materials using the distribution and the volume fractions for the number of magnetic materials.

12. The method of claim 11, further comprising:
configuring a number of supporting devices for the number of magnetic materials, wherein the number of supporting devices applies forces to the number of magnet materials.

13. The method of claim 12, wherein the number of supporting devices comprise at least one of permanent magnets, electromagnets, springs, and bearings.

14. The method of claim 11, wherein determining a distribution for the number of magnetic materials and volume fractions for the number of magnetic materials based on the force profile further comprises:
determining a magnetic force profile for the number of magnetic materials using the force profile; and
determining a magnetic property profile and volume fractions for the number of magnetic materials using the magnetic force profile, wherein the volume fractions for the number of magnetic materials comprises concentration of magnetic particles and voids in a material structure for the number of magnetic materials.

15. The method of claim 11, wherein the number of magnetic materials is distributed by varying feed ratios of filaments of different materials into a hotend.

16. The method of claim 11, wherein the number of magnetic materials comprise at least one of paramagnetic material, diamagnetic material, and ferromagnetic material.

17. The method of claim 11, wherein the distribution of ferromagnetic particles is configured to follow a single sawtooth or a double sawtooth along a horizontal axis.

18. The method of claim 11, wherein the distribution of ferromagnetic particles is configured to follow a double step function, a quadratic function, or a linear function along a horizontal axis.

19. The method of claim 11, wherein the number of magnetic materials have a geometry that varies in topology or porosity.

20. A method for manufacturing a number of magnetic materials, the method comprising:
determining a force profile for the number of magnetic materials, wherein the force profile correlates to varying magnetic properties of an electromechanical system;
determining a magnetic force profile for the number of magnetic materials using the force profile;
determining a magnetic property profile and volume fractions for the number of magnetic materials using the magnetic force profile, wherein the volume fractions for the number of magnetic materials comprises concentration of magnetic particles and voids in a material structure for the number of magnetic materials;
determining a distribution for the number of magnetic materials based on the magnetic property profile and volume fractions for the number of magnetic materials;
generating a manufacturing plan for the number of magnetic materials;
additively manufacturing the number of magnetic materials using the distribution for the number of magnetic materials and the manufacturing plan;
generating a magnetic structure for an electromagnetic system using the number of magnetic materials; and
configuring a number of supporting devices for the number of magnetic materials, wherein the number of supporting devices applies forces to the number of magnet materials.
